(19) United States
(12) Patent Application Publication
(10) Pub. No.: US 2014/0177287 A1
(43) Pub. Date: Jun. 26, 2014

(54) SWITCHING MODE POWER SUPPLY AND SWITCHING CONTROL CIRCUIT THEREOF

(71) Applicant: SAMSUNG ELECTRO-MECHANICS CO., LTD., Suwon (KR)

(72) Inventors: Hwan CHO, Suwon (KR); Jung Hyun KIM, Suwon (KR); Jung Chul GONG, Suwon (KR)

(73) Assignee: SAMSUNG ELECTRO-MECHANICS CO., LTD., Suwon, Gyunggi-do (KR)

(21) Appl. No.: 13/828,064

(22) Filed: Mar. 14, 2013

(30) Foreign Application Priority Data
Dec. 21, 2012 (KR) 10-2012-0151450

(51) Int. Cl. H02M 3/335

(52) U.S. Cl. CPC H02M 3/33507
USPC 363/21.09

(57) ABSTRACT

There are provided a switching-mode power supply (SMPS) and a switching control circuit thereof. The switching-mode power supply includes: a power supply circuit switching input power generated by rectifying AC power with a switching transistor to generate output power having a pre-set voltage level; and a switching control circuit having a charging and discharging unit generating a charge current to be charged in the switching transistor or a discharge current to be discharged from the switching transistor and a charging and discharging controller determining whether to charge or discharge the switching transistor according to a voltage level of the output power, wherein an amount of the charge current and an amount of the discharge current are linearly varied according to a voltage level of the input power.

### CROSS-REFERENCE TO RELATED APPLICATIONS

This application claims the priority of Korean Patent Application No. 10-2012-0151450 filed on Dec. 21, 2012, in the Korean Intellectual Property Office, the disclosure of which is incorporated herein by reference.

### BACKGROUND OF THE INVENTION

1. Field of the Invention

The present invention relates to a switching-mode power supply (SMPS) capable of linearly varying a charged or discharged current of a switching transistor according to a voltage level of input power, and a switching control circuit thereof.

2. Description of the Related Art

Currently, in order to supply a direct current (DC) voltage to domestically and industrial used electric or electronic products such as communications devices, personal computers (PCs), office automation (OA) devices, home appliances, and the like, switching-mode power supplies (SMPSs) have been widely used.

In an SMPS, AC power is rectified, smoothened and applied to a primary side of a transformer, and the power applied to the primary side of the transformer is induced to a secondary side of the transformer having a winding ratio previously set with the primary side according to a switching operation of a switching transistor, and the power induced to the secondary side of the transformer is rectified and smoothened to obtain DC power. Since a power flow is controlled by using a switching processor of the switching transistor, the SMPS has high efficiency, high durability, and is advantageous in terms of having compactness and being lightweight.

However, an SMPS involves a switching loss made in a turn-on time section during which a switching transistor is switched from an OFF operation to an ON operation and a turn-off time section during which the switching transistor is switched from an OFF operation to an ON operation.

When a voltage level of power applied to the primary side of the transformer is low, a switching loss is low, so it may be unnecessary to reduce a turn-on and turn-off time section of the transistor in consideration of a trade-off relationship with EMI characteristics, but in case in which the voltage level of power applied to the primary side of the transformer is high, a switching loss is increased, which is, thus, required to be reduced.

Patent document 1 below relates an SMPS start current control circuit and a control method thereof in which a variation of a start current is minimized and a start current is minimized and a start current after starting is minimized to reduce power loss, but without disclosing content of varying an amount of current charged in or discharged from a switching transistor stepwise according to a voltage level of power applied to the primary side transformer.

[Related Art Document]

(Patent document 1) Korean Patent Registration No. 10-0758257

### SUMMARY OF THE INVENTION

An aspect of the present invention provides a switching mode power supply apparatus capable of linearly varying an amount of current to be charged in or discharged from a switching transistor according to a voltage level of input power.

According to an aspect of the present invention, there is provided a switching-mode power supply including: a power supply circuit switching input power generated by rectifying AC power with a switching transistor to generate output power having a pre-set voltage level; and a switching control circuit having a charging and discharging unit generating a charge current to be charged in the switching transistor or a discharge current to be discharged from the switching transistor and a charging and discharging controller determining whether to charge or discharge the switching transistor according to a voltage level of the output power, wherein an amount of the charge current and an amount of the discharge current are linearly varied according to a voltage level of the input power.

Each of the amounts of the charge current and the discharge current may be increased linearly as the voltage level of the input power is increased.

The charging and discharging unit may include: a resistor having a pre-set level of resistance and having one end connected to a ground; an operational amplifier having a non-inverting terminal to which the input power is applied, an inverting terminal connected to the other end of the resistor, and an output terminal; and a current generation unit mirroring a current flowing to the resistor by the voltage level of the input power and the resistance of the resistor to generate the charge current and the discharge current.

The charging and discharging controller may include: a charging and discharging switching unit having a charging switch and a discharging switch for transmitting or cutting transmission of the charge current and the discharge current to a gate of the switching transistor; and a charging and discharging switch controller controlling a switching operation of the charging and discharging switching unit according to a voltage level of the output power.

The charging and discharging switch controller may control a switching operation of the charging switch and the discharging switch by setting a duty of the switching transistor according to a comparison result obtained by comparing a voltage level of the output power with a pre-set voltage level of a triangular wave.

The charging and discharging switch controller may include: a comparator comparing the output power with the voltage level of the triangular wave; a duty setting unit setting a duty of the switching transistor according to the comparison result from the comparator; and a switching signal generation unit generating a switching signal for differentially controlling switching operations of the charging switch and the discharging switch according to a duty signal output from the duty setting unit.

According to an aspect of the present invention, there is provided a switching control circuit of a switching-mode power supply (SMPS) switching input power generated by rectifying AC power with a switching transistor to generate output power having a pre-set voltage level, including: a charging and discharging unit generating a charge current to be charged in the switching transistor and a discharge current to be discharged from the switching transistor; and a charging and discharging controller determining whether to charge or discharge the switching transistor according to a voltage level of the output power, wherein an amount of the charge current and an amount of the discharge current are linearly varied according to a voltage level of the input power.

Each of the amounts of the charge current and the discharge current may be increased linearly as the voltage level of the input power is increased.

The charging and discharging unit may include: a resistor having a pre-set level of resistance and having one end connected to a ground; an operational amplifier having a non-inverting terminal to which the input power is applied, an inverting terminal connected to the other end of the resistor, and an output terminal; and a current generation unit mirroring a current flowing to the resistor by the voltage level of the input power and the resistance of the resistor to generate the charge current and the discharge current.

The charging and discharging controller may include: a charging and discharging switching unit having a charging switch and a discharging switch for transmitting or cutting transmission of the charge current and the discharge current to a gate of the switching transistor; and a charging and discharging switch controller controlling a switching operation of the charging and discharging switching unit according to a voltage level of the output power.

The charging and discharging switch controller may control a switching operation of the charging switch and the discharging switch by setting a duty of the switching transistor according to a comparison result obtained by comparing a voltage level of the output power with a pre-set voltage level of a triangular wave.

The charging and discharging switch controller may include: a comparator comparing the output power with the voltage level of the triangular wave; a duty setting unit setting a duty of the switching transistor according to the comparison result from the comparator; and a switching signal generation unit generating a switching signal for differentially controlling switching operations of the charging switch and the discharging switch according to a duty signal output from the duty setting unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a circuit diagram schematically illustrating a switching-mode power supply (SMPS) according to an embodiment of the present invention;

FIG. 2 is a circuit diagram of a charging and discharging unit as an element of the SMPS according to an embodiment of the present invention;

FIG. 3 is a circuit diagram of a charging and discharging controller as an element of the SMPS according to an embodiment of the present invention; and

FIGS. 4(a), 4(b), and 4(c) are graphs showing simulation results of the SMPS according to an embodiment of the present invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

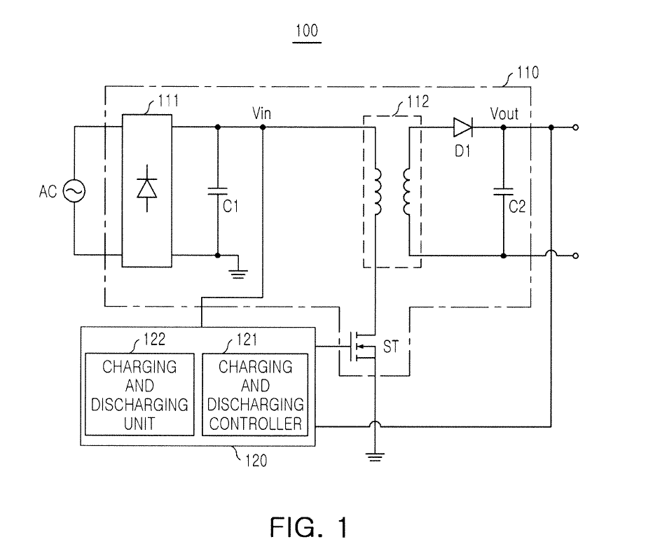

FIG. 1 is a circuit diagram schematically illustrating a switching-mode power supply (SMPS) according to an embodiment of the present invention. Referring to FIG. 1, an SMPS 100 according to an embodiment of the present invention may include a power supply circuit 110 and a switching control circuit 120.

The power supply circuit may include a rectifying unit 111, a first capacitor C1, a transformer 112, a switching transistor ST, a first diode D1, and a second capacitor C2.

The rectifying unit 111 and the first capacitor C1 may rectify and smooth power output from an AC power source to generate input power Vin. The input power is applied to a primary side winding of the transformer 112 to charge power in the primary side winding while the switching transistor ST is performing an ON operation, and induced to a secondary side winding while the switching transistor ST performs an OFF operation. Power induced to the secondary side winding of the transformer 112 is rectified and smoothened by the first diode D1 and the second capacitor C2 to generate output power Vout. The generated output power Vout may be supplied to a load connected to an output terminal OUT in parallel.

In FIG. 1, the switching transistor ST is illustrated as an N-channel field effect transistor (FET), but the present invention is not limited thereto and the switching transistor ST may also be a P-channel FET or a bipolar junction transistor (BJT).

The switching control circuit 120 may include a charging and discharging unit 121 generating a charge current to be charged in the switching transistor ST and a discharge current to be discharged from the switching transistor ST, and a charging and discharging controller 122 determining whether to charge or discharge the switching transistor ST according to a voltage level of output power. Here, each of current amounts of the charge current or discharge current may be varied stepwise according to a voltage level of the input power. In detail, each of current amounts of the charge current and discharge current may be increased linearly as the voltage level of the input power is increased.

Namely, as the voltage level of the input power is increased, the amount of current charged in the switching transistor ST or the amount of current discharged from the switching transistor ST are increased linearly to reduce a turn-on time section and turn-off time section of the switching transistor ST, and thus, switching loss may be lowered.

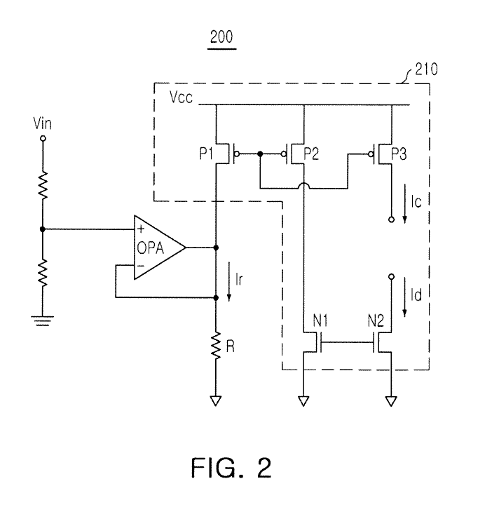

Hereinafter, the switching control circuit 120 according to an embodiment of the present invention will be described in detail with reference to FIGS. 2 through 4.

FIG. 2 is a circuit diagram of the charging and discharging unit 200 as an element of the SMPS according to an embodiment of the present invention. Referring to FIG. 2, the charging and discharging unit 200 according to an embodiment of the present invention may include a resistor R, an operational amplifier OPA, and a current generation unit 210.

The operational amplifier OPA may include a non-inverting terminal to which a divided voltage level of the input power Vin is applied, an inverting terminal connected to the resistor R, and an output terminal. The same potential as that of the divided voltage level of the input power Vin applied to the non-inverting terminal is maintained in the inverting terminal due to a virtual short.

In FIG. 2, it is illustrated that the inverting terminal of the operational amplifier OPA is connected to the resistor R and the non-inverting terminal is a terminal to which the divided voltage level of the input power Vin is applied, but it is merely illustrative and, obviously, the non-inverting terminal may be connected to the resistor R and the divided voltage level of the input power Vin may be applied to the inverting terminal.

The divided voltage level of the input power Vin maintained in the inverting terminal is applied to the resistor R having a pre-set level of resistance, a current Ir flows to the resistor R. The current Ir flowing to the resistor R is mirrored by a plurality of transistors P1, P2, P3, N1, and N2 provided in the current generation unit 210 to generate a charge current Ic and a discharge current Id.

The current Ir flowing to the resistor R is determined by the resistance of the resistor R and the divided voltage level of the input power, and here, as the divided voltage level of the input power is increased, a current amount of the current Ir flowing to the resistor R is increased, and as the current amount of the current Ir flowing to the resistor R is increased, current amounts of the charge current Ic and the discharge current Id generated by mirroring the current Ir flowing to the resistor R are also increased.

Namely, since the current amounts of the charge current Ic charged in and the discharge current Id discharged from the switching transistor ST are increased as the voltage level of the input power Vin is increased, a turn-on time section and a turn-off time section can be reduced, and thus, switching loss of the switching transistor can be lowered.

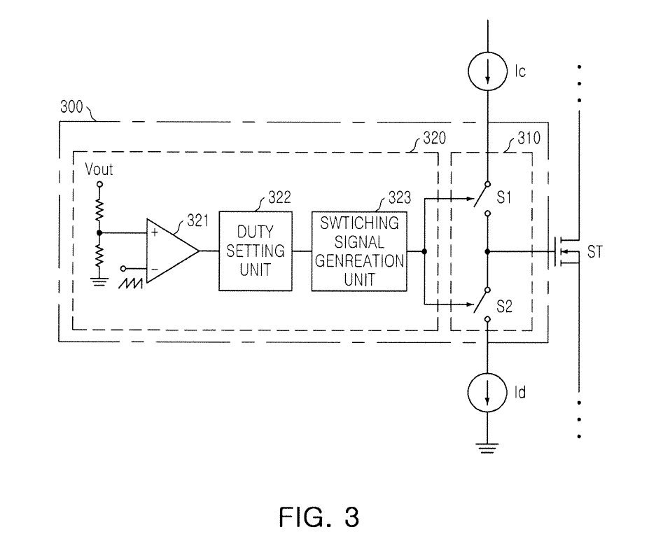

FIG. 3 is a circuit diagram of the charging and discharging controller 300 as an element of the SMPS according to an embodiment of the present invention. A charge current source Ic and a discharge current source Id illustrated in FIG. 3 are expressed to be equivalent to the charge current and discharge current generated by the charging and discharging unit 200 illustrated in FIG. 2.

The charging and discharging controller 300 may determine whether to charge or discharge the switching transistor ST according to a voltage level of the output power Vout. The charging and discharging controller 300 may include a charging and discharging switching unit 310 including a charging switch S1 and a discharging switch S2 and a charge and discharging switch controller 320 controlling a switching operation of the charge and discharging switching unit 310 and the charge and discharging switching unit 310.

The charging switch S1 is provided between a gate of the switching transistor ST and the charge current source Ic, and the discharging switch is provided between the gate of the switching transistor St and the discharge current source Ic. When the charging switch S1 is turned on, a current generated by the charge current source Ic is supplied to the switching transistor ST to turn on the switching transistor ST, and when the discharging switch S2 is turned on, the switching transistor is turned off by a current generated by the discharge current source Id.

The charge and discharging switch controller 320 may include a comparator 321, a duty setting unit 322, and a switching signal generation unit 323.

The comparator 321 compares the divided voltage level of the output power Vout with a pre-set voltage level of a triangular wave. The duty setting unit 322 generates a duty signal for setting a switching duty of the switching transistor ST according to a comparison result from the comparator 321. When the voltage level of the output power Vout is determined to be high according to the comparison result, the duty setting unit 322 generates a duty signal for reducing a duty ratio of the switching transistor ST, and when the voltage level of the output power Vout is determined to be low according to the comparison result, the duty setting unit 322 generates a duty signal for increasing a duty ratio of the switching transistor ST.

The switching signal generation unit 323 generates a switching signal for controlling switching of the charging switch S1 and the discharging switch S2 according to a duty signal from the duty setting unit 322. The switching signal generation unit 323 may differentially control an ON/OFF operation of the charging switch S1 and the discharging switch S2.

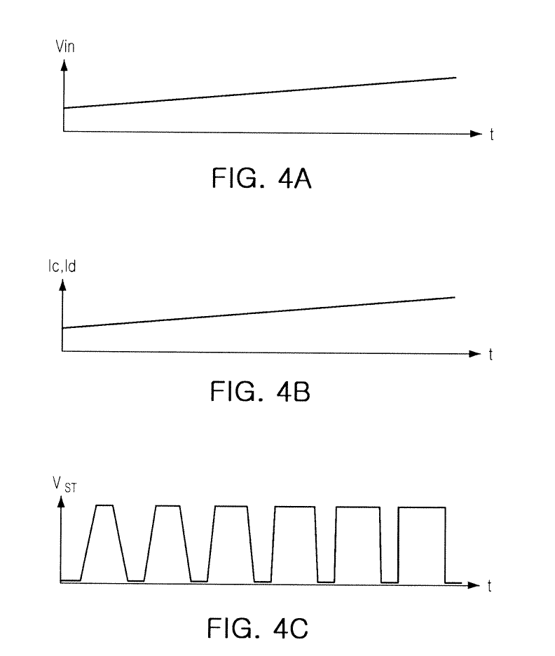

FIGS. 4(a), 4(b), and 4(c) are graphs showing simulation results of the SMPS according to an embodiment of the present invention. Specifically, FIG. 4(a) is a graph showing the input power Vin, FIG. 4(b) is a graph showing the charge current Ic and the discharge current Id, and FIG. 4(c) is a graph showing voltages V_{ST} at both ends of the switching transistor ST.

Referring to FIG. 4(a), it can be seen that a voltage level of the input power Vin is increased with the passage of time. Referring to FIG. 4(b), it can be seen that, as the voltage level of the input power Vin is increased, current amounts of the charge current Ic and the discharge current Id are also increased linearly. Referring to FIG. 4(c), it can be seen that, as the charge current Ic and the discharge current Id are increased, a turn-on time section and a turn-off time section of the switching transistor ST are reduced. Thus, switching loss of the switching transistor ST can be reduced.

As set forth above, according to embodiments of the invention, an amount of current charged in the switching transistor or an amount of current discharged from the switching transistor are linearly varied according to a voltage level of input power to reduce turn-on and turn-off time sections of the switching transistor, whereby switching loss of the switching transistor can be lowered.

While the present invention has been shown and described in connection with the embodiments, it will be apparent to those skilled in the art that modifications and variations can be made without departing from the spirit and scope of the invention as defined by the appended claims.

What is claimed is:

1. A switching-mode power supply comprising:
a power supply circuit switching input power generated by rectifying AC power with a switching transistor to generate output power having a pre-set voltage level; and
a switching control circuit having a charging and discharging unit generating a charge current to be charged in the switching transistor or a discharge current to be discharged from the switching transistor and a charging and discharging controller determining whether to charge or discharge the switching transistor according to a voltage level of the output power,
wherein an amount of the charge current and an amount of the discharge current are linearly varied according to a voltage level of the input power.

2. The switching-mode power supply of claim 1, wherein each of the amounts of the charge current and the discharge current is increased linearly as the voltage level of the input power is increased.

3. The switching-mode power supply of claim 2, wherein the charging and discharging unit comprises:
a resistor having a pre-set level of resistance and having one end connected to a ground;
an operational amplifier having a non-inverting terminal to which the input power is applied, an inverting terminal connected to the other end of the resistor, and an output terminal; and
a current generation unit mirroring a current flowing to the resistor by the voltage level of the input power and the resistance of the resistor to generate the charge current and the discharge current.

4. The switching-mode power supply of claim 1, wherein the charging and discharging controller comprises:
a charging and discharging switching unit having a charging switch and a discharging switch for transmitting or cutting transmission of the charge current and the discharge current to a gate of the switching transistor; and
a charging and discharging switch controller controlling a switching operation of the charging and discharging switching unit according to a voltage level of the output power.

5. The switching-mode power supply of claim 4, wherein the charging and discharging switch controller controls a switching operation of the charging switch and the discharging switch by setting a duty of the switching transistor according to a comparison result obtained by comparing a voltage level of the output power with a pre-set voltage level of a triangular wave.

6. The switching-mode power supply of claim 5, wherein the charging and discharging switch controller comprises:
a comparator comparing the output power with the voltage level of the triangular wave;
a duty setting unit setting a duty of the switching transistor according to the comparison result from the comparator; and
a switching signal generation unit generating a switching signal for differentially controlling switching operations of the charging switch and the discharging switch according to a duty signal output from the duty setting unit.

7. A switching control circuit of a switching-mode power supply (SMPS) switching input power generated by rectifying AC power with a switching transistor to generate output power having a pre-set voltage level, the switching control circuit comprising:
a charging and discharging unit generating a charge current to be charged in the switching transistor and a discharge current to be discharged from the switching transistor; and
a charging and discharging controller determining whether to charge or discharge the switching transistor according to a voltage level of the output power,
wherein an amount of the charge current and an amount of the discharge current are linearly varied according to a voltage level of the input power.

8. The switching control circuit of claim 7, wherein each of the amounts of the charge current and the discharge current is increased linearly as the voltage level of the input power is increased.

9. The switching control circuit of claim 8, wherein the charging and discharging unit comprises:
a resistor having a pre-set level of resistance and having one end connected to a ground;
an operational amplifier having a non-inverting terminal to which the input power is applied, an inverting terminal connected to the other end of the resistor, and an output terminal; and
a current generation unit mirroring a current flowing to the resistor by the voltage level of the input power and the resistance of the resistor to generate the charge current and the discharge current.

10. The switching control circuit of claim 7, wherein the charging and discharging controller comprises:
a charging and discharging switching unit having a charging switch and a discharging switch for transmitting or cutting transmission of the charge current and the discharge current to a gate of the switching transistor; and
a charging and discharging switch controller controlling a switching operation of the charging and discharging switching unit according to a voltage level of the output power.

11. The switching control circuit of claim 10, wherein the charging and discharging switch controller controls a switching operation of the charging switch and the discharging switch by setting a duty of the switching transistor according to a comparison result obtained by comparing a voltage level of the output power with a pre-set voltage level of a triangular wave.

12. The switching control circuit of claim 11, wherein the charging and discharging switch controller comprises:
a comparator comparing the output power with the voltage level of the triangular wave;
a duty setting unit setting a duty of the switching transistor according to the comparison result from the comparator; and
a switching signal generation unit generating a switching signal for differentially controlling switching operations of the charging switch and the discharging switch according to a duty signal output from the duty setting unit.
